(19) United States
(12) Patent Application Publication
(10) Pub. No.: US 2008/0095384 A1
(43) Pub. Date: Apr. 24, 2008

(54) APPARATUS AND METHOD FOR DETECTING VOICE END POINT

(75) Inventors: Baek-Kwon SON, Suwon-si (KR); Soon-Il Kwon, Seoul (KR); Sang-ki Kang, Suwon-si (KR); Jung-Hoon Park, Suwon-si (KR)

Correspondence Address: THE FARRELL LAW FIRM, P.C., 333 EARLE OVINGTON BOULEVARD, SUITE 701, UNIONDALE, NY, 11553, US

(73) Assignee: SAMSUNG ELECTRONICS CO., LTD., Suwon-si (KR)

(21) Appl. No.: 11/923,333

(22) Filed: Oct. 24, 2007

(30) Foreign Application Priority Data
Oct. 24, 2006 (KR) 103719/2006

(51) Int. Cl. H04B 15/00

(52) U.S. Cl. 381/94.1

(57) ABSTRACT

An apparatus and method for detecting a voice signal end point are provided, in which at least two microphones receive signals including voice and noise signals, and a voice end point detector distinguishes voice frames from noise frames in the received signals based on phase differences in respective frequencies between the received signals, and detecting the end point of the voice signal according to a time order of the voice frames and the noise frames.

### PRIORITY

This application claims priority under 35 U.S.C. § 119(a) to a Korean Patent Application filed in the Korean Intellectual Property Office on Oct. 24, 2006 and assigned Serial No. 2006-103719, the contents of which are incorporated herein by reference.

### BACKGROUND OF THE INVENTION

1. Field of the Invention

The present invention relates generally to an apparatus and method for receiving a signal through a MICrophone (MIC) and providing a voice solution, and more particularly, to an apparatus and method for detecting a voice end point in an apparatus with at least two MICs.

2. Description of the Related Art

Many techniques have been developed for receiving voice through a MIC and providing a variety of voice solutions such as voice recognition, echo cancellation, noise elimination and voice compression in a MIC-equipped apparatus.

Among them, a major voice solution called voice end point detection distinguishes a voiced period from an unvoiced period in a signal received through a MIC and processes only the voiced period or eliminates unnecessary information of a noise period, thereby reducing computation volume, enabling efficient memory use and improving performance.

A voice end-point detector mostly equipped in voice input devices uses a single MIC and distinguishes a voiced period from an unvoiced period based on energy information about a signal received at the MIC.

In general, a voice signal in the voiced period is separated into voiced and unvoiced sound. The voiced sound has more energy than the unvoiced sound, whereas the unvoiced sound is similar to noise in waveform and has a larger zero crossing rate than the voiced sound.

The voice end-point detector sets thresholds for a mute period based on the average energy and average zero crossing rate of an initial mute period. It detects a rough start and end of voice by comparing the energy of a later input frame with an energy threshold, and then detects an accurate start and end of the voice by comparing the frame with the initial period in terms of average zero crossing rate.

FIG. 1 illustrates a conventional voice end-point detector for detecting the voice end point of a signal received through a single MIC.

Referring to FIG. 1, an Analog-to-Digital (A/D) converter 102 converts a signal received through a MIC 100 to a digital signal which it outputs to an energy calculator 104 and a zero crossing rate calculator 106. The energy calculator 104 and the zero crossing rate calculator 106 calculate the average energy and zero crossing rate of an initial period being a mute period. A threshold calculator 108 calculates thresholds for the mute period based on the average energy and the zero crossing rate received from the energy calculator 104 and the zero crossing rate calculator 106. A decider 110 detects a voiced period by comparing the energy value received from the energy calculator 104 with an energy threshold received from the threshold calculator 108 and comparing the zero crossing rate received from the zero crossing rate calculator 106 with a zero crossing rate threshold received from the threshold calculator 108, and outputs the start and ends points 112 and 114 of the voiced period.

The energy information used in the conventional voice end-point detector is distorted by noise and thus it is difficult to locate a voice signal based on the energy information. Particularly, the voice end-point detector does not ensure performance at or below a Signal-to-Noise Ratio (SNR) of 10 dB. When the voice signal is located based on a zero crossing rate, voice is difficult to distinguish from voice-like noise and is very susceptible even to small noise.

As described above, the conventional voice end-point detector is not effective in accurately locating a voice signal in a signal received through a MIC under a noise environment. Even if the conventional voice end-point detector operates precisely in a certain noise environment, it performs poorly in other noise environments.

Voice-like noise such as babble that is made in public places such as department stores and terminals has similar characteristics to a voice signal, even at a low level. Therefore, a voiced period is difficult to detect against the voice-like noise.

Most voice input devices are equipped with a single MIC. The voice end point detection technology based on voice received through the single MIC has limitations in detecting the end point of voice.

As described above, voice end point detection is essential in realizing many technologies including noise elimination, voice recognition, voice compression and voice coding. Accordingly, there exists a need for developing a technique for effectively using the voice solutions in a variety of noise environments.

As stated before, however, considering the limitations of the conventional voice end point detection in a signal received through a single MIC under various noise environments, it is preferable to use a plurality of MICs to improve user convenience in accurate voice recognition and noise cancellation. Yet, there are no known techniques for detecting the end point of voice using a plurality of MICs.

### SUMMARY OF THE INVENTION

An aspect of the present invention is to address at least the problems and/or disadvantages and to provide at least the advantages described below. Accordingly, an aspect of the present invention is to provide an apparatus and method for detecting the end point of voice in an apparatus equipped with at least two MICs.

An aspect of the present invention provides an apparatus and method for detecting the end point of voice using the phase difference between signals received through at least two MICs.

In accordance with the present invention, there is provided an apparatus for detecting the end point of voice, in which at least two MICs receive signals including voice and noise signals, and a voice end point detector distinguishes voice frames from noise frames in the received signals based on phase differences in respective frequencies between the received signals, and detecting the end point of the voice signal according to a time order of the voice and the noise frames.

In accordance with the present invention, there is provided a method for detecting the end point of voice, in which signals including voice and noise signals are received through at least two MICs, voice frames are distinguished from noise frames in the received signals based on phase differences in respective frequencies between the received signals, and the end point of the voice signal is detected according to a time order of the voice and the noise frames.

### BRIEF DESCRIPTION OF THE DRAWINGS

The above and other objects, features and advantages of certain exemplary embodiments of the present invention will be more apparent from the following detailed description taken in conjunction with the accompanying drawings, in which:

FIG. 1 illustrates a conventional voice end-point detector that detects the end of voice in a signal received through a single MIC;

FIG. 2 illustrates a multi-MIC apparatus having a voice end-point detector for detecting the end point of voice according to the present invention;

FIGS. 3A and 3B illustrate a phase delay compensation method according to the positions of the MICs in the multi-MIC apparatus to which the present invention is applied;

FIG. 4 illustrates a voice end point detection method in the voice end-point detector according to the present invention;

FIGS. 5A, 5B and 5C are graphs comparing phase differences when only voice is input to MIC #1 and MIC #2, only noise is input to the MICs, and both voice and noise are input to the MICs; and

FIG. 6 illustrates detection of the start and end points of voice in signals received through the MICs according to the present invention.

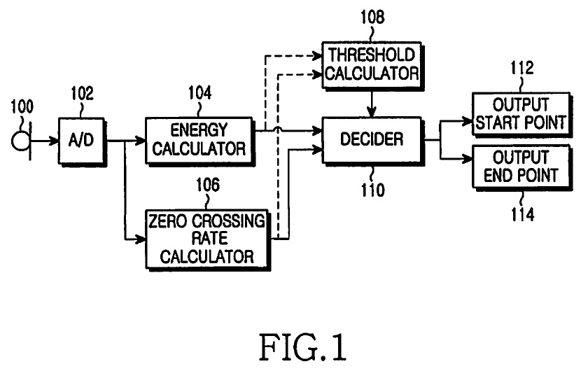

Throughout the drawings, the same drawing reference numerals will be understood to refer to the same elements, features and structures.

### DETAILED DESCRIPTION OF THE PREFERRED EMBODIMENTS

The matters defined in the description such as a detailed construction and elements are provided to assist in a comprehensive understanding of the present invention. Accordingly, those of ordinary skill in the art will recognize that various changes and modifications of the embodiments described herein can be made without departing from the scope and spirit of the invention. Also, descriptions of well-known functions and constructions are omitted for the sake of clarity and conciseness.

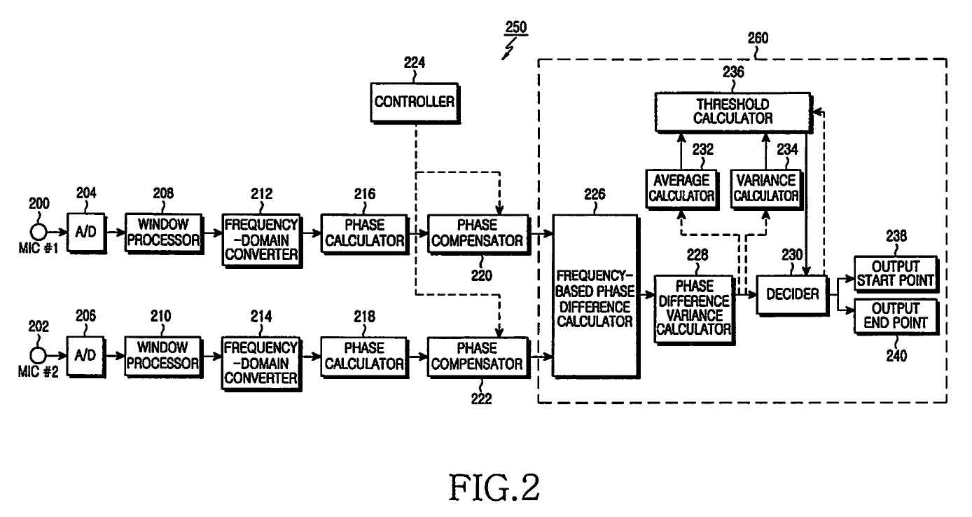

FIG. 2 illustrates a multi-MIC apparatus 250 having a voice end-point detector 260 for detecting the end point of voice according to the present invention.

For a better understanding of the present invention, it is assumed that the multi-MIC apparatus 250 has two MICs. Herein, an apparatus equipped with at least two MICs can be a mobile terminal such as a cellular phone, a Personal Digital Assistant (PDA) and a laptop Personal Computer (PC), or a medium for recording and reproducing video such as a television or a camcorder. That is, the present invention is applicable to any apparatus equipped with at least two MICs.

Referring to FIG. 2, two MICs 200 and 202 (MIC #1 and MIC #2) convert received voice to analog signals. A/D converters 204 and 206 convert the analog signals received from the MICs 200 and 202 to digital signals.

Window processors 208 and 210 divide the successive digital signals received from the A/D converters 204 and 206 into frames. Frequency-domain converters 212 and 214 convert the time-domain signals received from the window processors 208 and 210 to frequency-domain signals according to Equation (1), as follows:

$$X ( k ) = {\sum }_{n = 0}^{N - 1} x ( n ) {e}^{- j 2 π kn / N} k = 0 , 1 , … , N - 1 \qquad ( 1 )$$

where x(n) denotes a sample value of an input time-domain signal, X(k) denotes the frequency-domain value of the sample value x(n) after time-frequency conversion, k denotes a Fast Fourier Transform (FFT) point value and N denotes a frame size. Thus, one frame has N samples. Given a frame size of 20 ms for a signal with a sampling rate of 8 khz, one frame has 160 samples (=8 khz×20 ms), that is, N=160.

Phase calculators 216 and 218 extract phase information ∠X(k) about the sample values from the frequency-domain signals received from the frequency-domain converters 212 and 214 by Equation (2), as follows:

$$∠ X ( k ) = {tan}^{- 1} ( \frac{Im ( X ( k ) )}{Re ( X ( k ) )} ) . k = 0 , 1 , … , N - 1 \qquad ( 2 )$$

Regarding the voice of a speaker, a phase delay compensation value is preset considering the distance between the MICs 200 and 202 and a sampling frequency in order to minimize the time delay between the input signals to the two MICs 200 and 202 irrespective of their positions. That is, since a signal generated from a sound source may be input to the MICs 200 and 202 at different times according to their positions, a value for compensating for the resulting phase delay should be preset by a manufacturer or a user. In FIG. 2, a controller 224 provides the phase delay compensation value to phase compensators 220 and 222. For example, as the MIC 200 and the MIC 202 reside at different positions, a voice signal generated from the same sound source arrives at the MICs 200 and 202 at different time points. To prevent the voice signal from having a phase delay caused by the time delay, the phase delay compensation value is created considering the positions of the MICs 200 and 202. By use of the phase delay compensation value, it can be assumed that the voice signal is input simultaneously to the MICs 200 and 220 without a time delay.

In this case, to prevent a signal generated from the sound source from having a phase delay caused by a time delay, the earlier MIC input signal is delayed to the later MIC input signal, so that the voice signal generated from the sound source can be received simultaneously at the two MICs without a time delay.

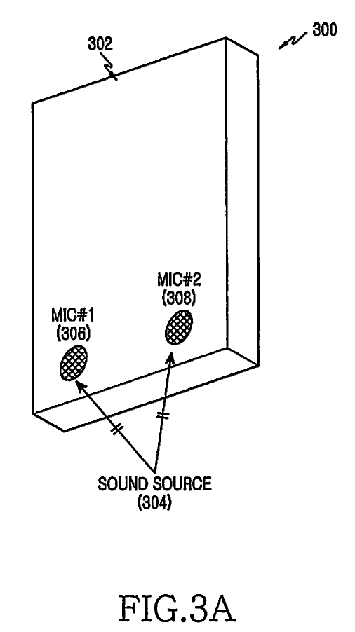

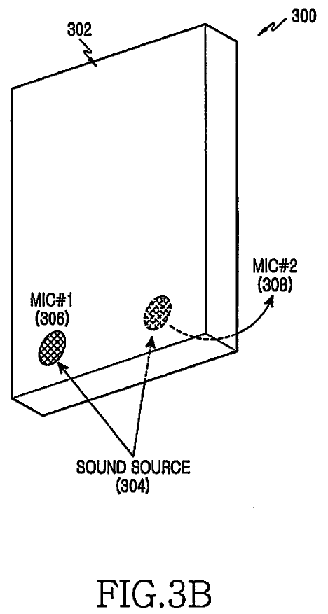

FIGS. 3A and 3B illustrate a phase delay compensation method according to the positions of the MICs in the multi-MIC apparatus to which the present invention is applied.

Referring to FIG. 3A, the two MICs 306 and 308 are faced in the same direction on a frontal surface 302 of a multi-MIC apparatus 300. The MICs 306 and 308 (MIC #1 and MIC #2) receive a signal from a sound source 304 with no phase difference. Referring to FIG. 3B, when MICs 306 and 308 are positioned respectively on the frontal surface 302 and a rear surface of the multi-MIC apparatus 300, they receive a signal from the sound source 304 with different phases. In the present invention, the start and end points of voice are detected by compensating for the phase difference according to the positions of the MICs, calculating the averages and variances of voice and noise at the same time position in the same frame.

When the MICs 306 and 308 are positioned on the frontal surface 302 of the multi-MIC apparatus 300 and the sound source 304 is between the two MICs 306 and 308, as illustrated in FIG. 3A, they receive a signal with no phase difference at the same time. However, if the MIC 306 is on the frontal surface 302 and the MIC 308 is on the rear surface of the multi-MIC apparatus 300, a signal from the sound source 304 arrives at the MIC 306 earlier than at the MIC 308 by t seconds. Hence, the earlier MIC input signal is delayed by t seconds so as to eliminate the time delay between the two signals, and thus to avoid a phase difference between the two signals.

The phase compensators 220 and 222 receive the phase delay compensation value from the controller 224 and change the phase information of their input signals according to Equation (3), as follows:

∠X′(k)=∠X(k)−(2πk/N)·delay (3)

where ∠X′(k) denotes a compensated phase, 2πk/N converts delay being a time-scaled value to a frequency-scaled value, and delay denotes the phase delay compensation value. In accordance with the present invention, when only one of the MICs 200 and 202 can be changed in position, phase compensation is performed according to the variable position of the MIC. If the MICs 200 and 202 are both variable in position, phase compensation needs to be performed according to their positions.

The phase compensation in the phase compensators 220 and 222 eliminates the phase difference between the voice signals input to the MICs 200 and 202.

A frequency-based phase difference calculator 226 calculates the phase difference between the phase information received from the respective phase compensators 220 and 222 on a frequency-by-frequency basis and maps the phase difference for frequency k to a value ranging from −π to π by Equations (4), (5), and (6). In Equation (4),

Phase_Diff(k)=∠X′_{mic1}(k)−∠X′_{mic2}(k) (4)

where ∠X′_{mic1}(k) and ∠X′_{mic2}(k) respectively denote the phase values of the signals received at the MICs 200 and 202, which have been compensated by Equation (3).

Considering that the phase difference for frequency k should be mapped to a value ranging from −π to π, it can also be computed by Equations (5) and (6), instead of Equation (4). Since the phase values of voice and noise frames can be represented as a periodic function, phase values beyond the range between −π to π can also be mapped within the range between −π to π. Accordingly, the phase difference can be computed by Equations (5) and (6). In Equation (5),

Phase_Diff(k)′=mod(Phase_Diff(k),2π) (5)

where Phase_Diff(k)′ denotes one of −π to π to which the phase difference Phase_Diff(k) calculated by Equation (4) is mapped by 2π-modulo operation of Phase_Diff(k). The modulo operation is performed by Equation (6), as follows:

$$phase\_Diff ( k ) = \{ \begin{matrix} if & phase\_Diff ( k ) > π , & \vert phase\_Diff ( k ) - 2 π \vert \\ elseif & phase\_Diff ( k ) < - π , & \vert phase\_Diff ( k ) + 2 π \vert \\ else & - π \leq phase\_Diff ( k ) \leq π , & \vert phase\_Diff ( k ) \vert\end{matrix} \qquad ( 6 )$$

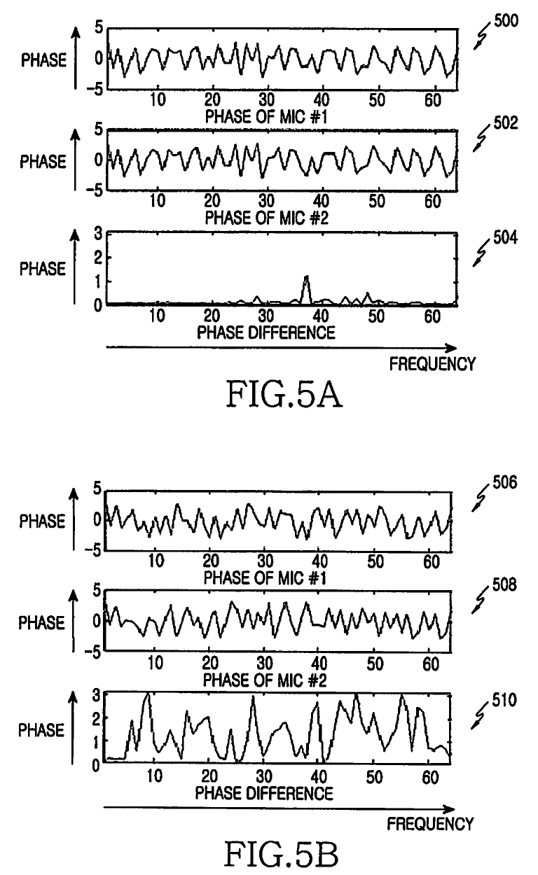

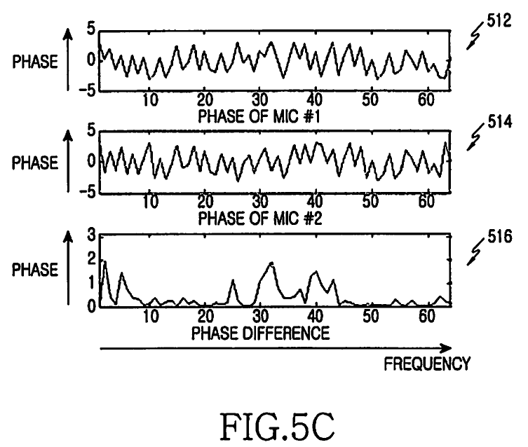

The phase differences for k frequencies calculated by the frequency-based phase difference calculator 226 are small because the voice signal of the speaker has been compensated in the phase compensators 220 and 222 to eliminate the time delay between the two MIC inputs. Therefore, the variances of the phase differences are small as described in Equation (7), which will be described with reference to FIGS. 5A, 5B and 5C.

Phase_Diff_{voice}(k)≈0 (7)

where Phase_Diff_{voice}(k) denotes the phase difference between voice signals received at the MICs 200 and 202.

FIG. 5A is a graph comparing the phase differences between signals input to the MICs #1 (200) and #2 (202) when only voice frames are input to them. Reference numeral 500 denotes the phase of a voice signal input to the MIC 200, reference numeral 502 denotes the phase of a voice signal input to the MIC 202, and reference numeral 504 denotes the phase difference between the voice signals input to the MICs 200 and 202.

Referring to FIG. 5A, when only voice signals are input to the MICs 200 and 202, the phase difference between them is approximate to 0, as described in Equation (7).

In contrast, noise signals input from other directions than that of the speaker have a time delay between the MICs 200 and 202, thus causing a large phase difference for each frequency, as expressed in Equation (8).

FIG. 5B is a graph comparing the phase differences between signals input to the MICs #1 (200) and #2 (202) when only noise frames are input to them. Reference numeral 506 denotes the phase of a noise signal input to the MIC 200, reference numeral 508 denotes the phase of a noise signal input to the MIC 202, and reference numeral 510 denotes the phase difference between the noise signals input to the MICs 200 and 202. It is noted from the curve 510 that the noise signals input to the MICs 200 and 202 have very large phase differences, as shown in Equation (8):

Phase_Diff_{noice}(k)>>0 (8)

where Phase_Diff_{noice}(k) denotes the phase difference between noise signals received at the MICs 200 and 202.

FIG. 5C is a graph comparing the phase differences between signals input to the MICs #1 (200) and #2 (202) when voice and noise frames are input to them. Reference numeral 512 denotes the phase of a voice and noise signal input to the MIC 200, reference numeral 514 denotes the phase of a voice and noise signal input to the MIC 202, and reference numeral 516 denotes the phase difference between the voice and noise signals input to the MICs 200 and 202. It is noted from the curve 516 that the voice and noise signals input to the MICs 200 and 202 have phase differences larger than the voice signals input to them but smaller than the noise signals input to them.

As noted from FIGS. 5A, 5B and 5C, voiced and unvoiced periods have different variances with respect to the k phase differences calculated by the frequency-based phase difference calculator 226. Thus, a variance calculator 228 calculates the variances of the phase differences for the k frequencies by Equation (9) and a decider 230 uses these phase difference variances as a criterion of distinguishing the voiced period from the unvoiced period. In Equation (9),

PD_Var=Var(Phase_Diff(k)) (9)

where PD_Var denotes the variance of Phase_Dif(k) calculated by Equation (4). For example, if k is 3 and the frequency-based phase difference calculator 226 calculates phase differences for frequencies of 1 Hz, 10 Hz and 1 KHz, the phase difference variance calculator 228 calculates the variances of the phase differences.

For 256 FFT points, for instance, the phase difference calculator 226 outputs 256 phase differences and the phase difference variance calculator 228 outputs 256 variances of the phase differences.

The phase difference variance calculator 228 calculates the variances of the phase differences received from the frequency-based phase difference calculator 226 on a frame-by-frame basis according to Equation (9).

Since an initial period during which the MICs 200 and 202 initially receive signals is full of only muted sound, the initial period is assumed to be a mute period. An average calculator 232 and a variance calculator 234 calculate the average and variance of phase difference variances received from the phase difference variance calculator 226 during the mute period.

The average calculator 232 calculates the average M of the phase difference variances of P frames received for the time period by Equation (10) and the variance calculator 234 calculates the variance V of the phase difference variances of the P frames by Equation (11), as follows:

$$M = \frac{I}{P} {\sum }_{i = 0}^{P - 1} {PD\_var}_{i} \qquad ( 10 )$$

where P denotes the total number of frames received for the time period and i denotes the number of a current frame input to the MICs 200 and 202, and

$$V = \frac{I}{P} {\sum }_{i = 0}^{P - 1} {( {PD\_var}_{i} - M )}^{2} \qquad ( 11 )$$

where P denotes the total number of frames received for the time period and i denotes the number of a current frame input to the MICs 200 and 202.

A threshold calculator 236 calculates a threshold using M and V by Equation (12). When the multi-MIC apparatus is powered-on, the threshold calculator 236 calculates the threshold for the time period, starting from the time of power-on. Thereafter, if noise frames are successively received for a time period, the threshold calculator 236 calculates a new threshold. In Equation (12),

Threshold=M−α×V (12)

where α denotes a constant that has been empirically obtained from tests or field tests, M denotes the average of the phase difference variances of P frames received for the time period, and V denotes the variance of the phase difference variances of the P frames.

After the threshold calculation is completed, the decider 230 compares the phase difference variance of a current frame with the threshold and determines whether the current frame is a noise frame or a voice frame according to the comparison result. The comparison is performed frame by frame.

That is, when signals are input to the MICs 200 and 202, a threshold is calculated using frames received for an initial period. After the initial period, the threshold is compared with the phase difference variance of a current frame, to thereby determine whether the current frame is a voice frame or a noise frame according to Equation (13), as follows:

if PD_varᵢ<threshold,voice_frame

if PD_varᵢ≧threshold,noise_frame (13)

where PD_varᵢ denotes the phase difference variance of a current frame i. If the phase difference variance is less than the threshold, the current frame i is a voice frame (voice_frame) and if the phase difference variance is equal to or greater than the threshold, the current frame i is a noise frame (noise_frame).

If a number or more of noise frames continuously appears, the decider 230 controls the threshold calculator 236 to create a new threshold using the phase difference variance of the repeated noise period by Equation (14). To decide whether the noise period lasts for a set time, the decider 230 may be provided with a counter. In Equation (14),

threshold_update=M′−α×V′, during continuous noise frames (14)

where M′ denotes the average of the phase difference variances of the new noise period, V′ denotes the variance of the phase difference variances for the new noise period, and threshold_update denotes the new updated threshold.

As previously described, if the current frame is a voice frame (voice_frameᵢ) and the previous frame is a noise frame (noise_frameᵢ₋₁), the decider 230 sets the first sample (sample 0) of the i^{th} frame as the start point of voice (voice_start) 238. If the current frame is a noise frame (noise_frameᵢ) and the previous frame is a voice frame (voice_frameᵢ₋₁), the decider 230 sets the last sample (sample N−1) of the i^{th} frame as the end point of voice (voice_end) 240.

The detection of the start and ends points of voice is expressed by Equation (15), as follows:

if (noise_frameᵢ₋₁voice_frameᵢ),voice_start=voice_frameᵢ(0)

if (voice_frameᵢ₋₁noise_frameᵢ),voice_end=voice_frameᵢ(N−1) (15)

where N denotes the number of samples per frame. If a 20-ms frame is created out of an 8-khz sampling signal, 160 samples exist per frame and thus N is 160.

The frequency-based phase difference calculator 226, the phase difference variance calculator 228, the average calculator 232, the variance calculator 234, the threshold calculator 236 and the decider 230 collectively form the voice end-point detector 260. In the present invention, the start and end points of a voice signal are referred to as first and second end points, respectively.

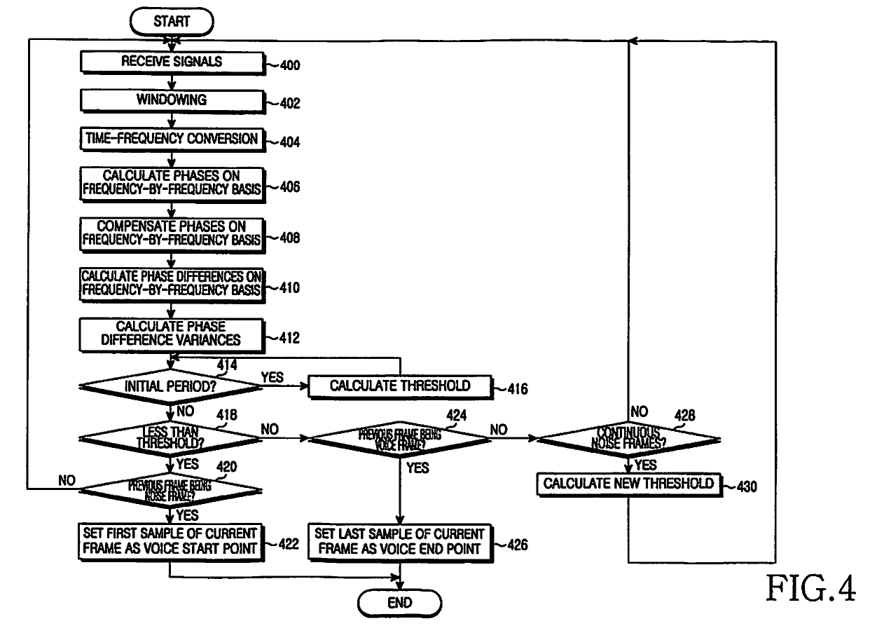

FIG. 4 is a flowchart of a voice end point detection method in the voice end-point detector according to the present invention.

Referring to FIG. 4, upon input of signals to the MICs 200 and 202, the A/D converters 204 and 206 convert the received signals to digital signals in step 400. The window processors 208 and 210 perform windowing on the digital signals on a frame-by-frame basis in step 402. In step 404, the frequency-domain converters 212 and 214 convert the time-domain signals received in frames from the window processors 208 and 210 to frequency-domain signals. The phase calculators 216 and 218 calculate the phases of the frequency-domain signals in step 406.

In step 408, the phase compensators 220 and 222 compensate the phases for the respective frequencies calculated by the phase calculators 216 and 218 by a phase delay according to a phase delay compensation value received from the controller 224. The frequency-based phase difference calculator 226 calculates the phase differences between the phase-compensated signals on a frequency-by-frequency basis by Equations (4), (5) and (6) in step 410. The phase difference variance calculator 228 calculates the variances of the phase differences by Equation (9) in step 412.

If it determines that a current period is an initial period in step 414, the decider 230 controls the threshold calculator 236 to calculate a threshold in step 416. Specifically, the decider 230 presets a period from initial activation of the MICs 200 and 202 to the input of voice signals to them and designates the period as the initial period in step 414. In step 416, the average calculator 232 and the variance calculator 234 calculate the average M of the phase difference variances of P frames received during the initial period and the variance V of the phase difference variances by Equations (10) and (11). Then, the threshold calculator 236 calculates the threshold using M and V by Equation (12) and provides it to the decider 230.

However, if the current period is not the initial period in step 414, the decider 230 compares the phase difference variance of the current frame i with the threshold in step 418.

If the phase difference variance of the current frame i is less than the threshold, the decider 230 determines whether the previous frame i−1 is a noise frame in step 420. If the previous frame i−1 is a noise frame, the decider 230 sets the first sample (sample #0) of the current frame i as the start point of voice in step 422. If the previous frame i−1 is not a noise frame in step 420, which implies that the previous frame is a voice frame and the current frame is also a voice frame, that is, a voice period still lasts, the decider 230 receives the next frame in step 400.

If the phase difference variance of the current frame i is equal to or greater than the threshold, the decider 230 determines whether the previous frame i−1 is a voice frame in step 424. If the previous frame i−1 is a voice frame, the decider 230 sets the last sample (sample #N−1) of the current frame i as the end point of voice in step 426. If the previous frame i−1 is not a voice frame in step 424, the decider 230 monitors detection of successive noise frames for a set time in step 428. Upon detection of the continuous noise frames, the decider 230 controls the threshold calculator 236 to calculate a new threshold in step 430 and then returns to step 400 in order to compare the phase difference variance of a new frame with the new threshold. However, if successive unvoiced frames have been received in step 428, there is no need for calculating a new threshold. Thus, the decider 230 returns to step 400 in which it receives the next frame.

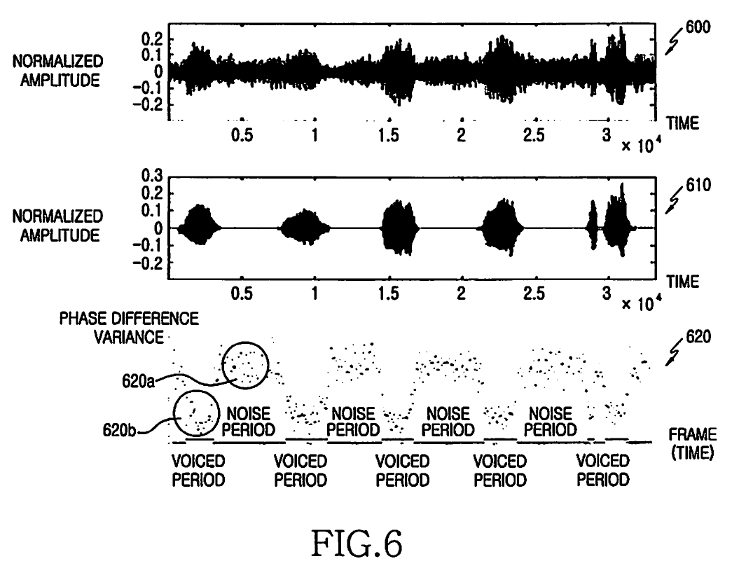

FIG. 6 illustrates detection of the start and end points of voice signals in signals received through the MICs according to the present invention.

Referring to FIG. 6, reference numeral 610 denotes a noise-free voice signal and reference numeral 600 denotes the amplitude of a mixture of voice and noise signals input to a MIC. When the voice and noise signal 600 is received, the voice end-point detector cannot detect the end point of voice because it does not distinguish noise from voice. However, the present invention detects the end point of the voice signal 610 using phase difference variances 620. If the signals input to the MICs 200 and 202 have large phase difference variances 620a, it is determined that they are noise signals. If the signals input to the MICs 200 and 202 have small phase difference variances 620b, it is determined that they are voice signals and the end point of voice is detected.

As is apparent from the above description, the present invention advantageously provides an efficient voice solution since the end point of voice is detected in an apparatus with at least two MICs.

While the invention has been shown and described with reference to certain exemplary embodiments of the present invention thereof, it will be understood by those skilled in the art that various changes in form and details may be made therein without departing from the spirit and scope of the present invention as defined by the appended claims and their equivalents.

What is claimed is:

1. An apparatus for detecting a voice signal end point, comprising:
at least two microphones for receiving signals including voice and noise signals; and
a voice end point detector for distinguishing voice frames from noise frames in the received signals based on phase differences in respective frequencies between the received signals, and detecting the end point of the voice signal according to a time order of the voice frames and the noise frames.

2. The apparatus of claim 1, wherein if the voice frame is detected from the signals and a frame previous to the detected voice frame is the noise frame, the voice end point detector determines a first sample of the voice frame as a first end being a start point of the voice signal.

3. The apparatus of claim 2, wherein if the noise frame is detected from the signals and a frame previous to the detected noise frame is the voice frame, the voice end point detector determines a last sample of the voice frame as a second end point being the end point of the voice signal.

4. The apparatus of claim 1, wherein the voice end point detector calculates the variance of the phase difference between the received signals for one frame, and determines that the frame is a voice frame if the phase difference variance is less than a threshold and determines that the frame is a noise frame if the phase difference variance is equal to or greater than the threshold.

5. The apparatus of claim 4, wherein the voice end point detector calculates the variances of phase differences in respective frequencies between the received signals for a time period and calculates the threshold using the average and variance of the phase difference variances.

6. The apparatus of claim 5, wherein the voice end point detector calculates the threshold by the following equation,
Threshold=M−α×V
where α denotes a constant, M denotes the average of the phase difference variances of a number P of received frames among the signals, and V denotes the variance of the phase difference variances of the P frames.

7. The apparatus of claim 1, further comprising a phase compensator for compensating for a phase delay generated according to positions of the at least two MICs in the apparatus when the voice signal is created from a sound source and provided to the at least two MICs.

8. A method for detecting a voice signal end point, comprising:
receiving signals including voice and noise signals through at least two microphones;
distinguishing voice frames from noise frames in the received signals based on phase differences in respective frequencies between the received signals; and
detecting the end point of the voice signal according to a time order of the voice frames and the noise frames.

9. The method of claim 8, wherein the end point detection includes determining, if the voice frame is detected from the signals and a frame previous to the detected voice frame is the noise frame, a first sample of the voice frame as a first end being the start point of the voice signal.

10. The method of claim 9, wherein the end point detection includes determining, if the noise frame is detected from the signals and a frame previous to the detected noise frame is the voice frame, a last sample of the voice frame as a second end point being the end point of the voice signal.

11. The method of claim 8, wherein the distinguishing step further comprises:
calculating a variance of the phase difference between the received signals for one frame; and
determining that the frame is a voice frame if the phase difference variance is less than a threshold; and
determining that the frame is a noise frame if the phase difference variance is equal to or greater than the threshold.

12. The method of claim 11, wherein the threshold is calculated using the average and variance of the variances of phase differences in respective frequencies between the received signals for a time period.

13. The method of claim 12, wherein the threshold is calculated by the following equation,
Threshold=M−α×V
where α denotes a constant, M denotes the average of the phase difference variances of a number P of received frames among the signals, and V denotes the variance of the phase difference variances of the P frames.

14. The method of claim 8, further comprising compensating for a phase delay generated according to positions of the at least two MICs in the apparatus when the voice signal is created from a sound source and provided to the at least two MICs.
